(19) United States
(12) Patent Application Publication
(10) Pub. No.: US 2011/0288882 A1
(43) Pub. Date: Nov. 24, 2011

(54) System to Prevent Medical Billing Fraud

(76) Inventor: George M. Halow, El Paso, TX (US)

(21) Appl. No.: 13/195,475

(22) Filed: Aug. 1, 2011

Related U.S. Application Data
(63) Continuation-in-part of application No. 10/042,236, filed on Jan. 11, 2002.

(51) Int. Cl. G06Q 50/00

(52) U.S. Cl. 705/2

(57) ABSTRACT

A system and method of determining and preventing medical billing fraud in the posting of medical insurance claims in which a clearing house is established for receiving information transmitted from a plurality of providers administering treatment covered by various insurance plans. For example, a computer system located in the clearing house would monitor the information provided by each of the providers to determine whether the providers submitted multiple claims for a particular period of time. The computer system located in the clearing house would also determine whether other inappropriate claims were made by the providers. If the computer system located in the clearing house determines that the treatments were proper, the providers would be paid by the computer system located in the clearing house in a timely manner. If the computer system located in the clearing house determines that the potential for medical billing fraud exists, payments to the health care provider may be delayed.

### CLAIM OF PRIORITY INVENTION

This application is a Continuation-in-Part of U.S. patent application Ser. No. 10/042,236, filed on Jan. 11, 2002, entitled “Medical Billing System to Prevent Fraud”, the entire disclosure of which is hereby incorporated by reference into the present disclosure.

### FIELD

The present invention is directed to a system and method of analyzing medical billing information for the purpose of preventing fraud, such as multiple billing from a health care provider for a specified single time period.

### BACKGROUND

It will come as no surprise to most individuals that the cost of health care in recent years has increased at a much greater rate than that of inflation. These individuals realize that the lack of adequate health care benefits could cause a massive outlay of money if that individual or a member of the individual's family were diagnosed with a very serious illness requiring a long stay in a hospital, nursing home or other health care facility. Similarly, if that individual or a member of the individual's family were involved in an accident, also requiring a long stay in a medical facility or would require extensive medical procedures, a drain on the family's resources would be created, even to the extent of requiring a personal bankruptcy. Therefore, to protect an individual or the individual's family from such financial hardship, the acquisition of adequate medical insurance sometimes requires an individual to make various decisions, such as employment, based upon the type and extent of medical insurance provided by various employers.

While the high cost of health care often results from new and remarkable advances in medical technology for diagnosing and treating various ailments and medical conditions, unfortunately, some of the increase in medical costs can be attributed to medical billing fraud. This medical billing fraud could include situations in which various medical personnel are: a) conducting treatments not required from a particular diagnosis, or b) never authorized by various medical insurance companies, including workman's compensation. Additionally, this medical billing fraud results from c) various medical personnel billing for multiple treatment procedures during a particular time period. Due to the vast amounts of paperwork necessitated by various medical billing procedures, it is often very difficult for those reviewing medical bills prior to payment to detect such medical billing fraud in a patient's record. Similarly, it also is difficult to compare one patient record to another to determine if evidence of fraud may be present. The cost of this medical billing fraud is often passed on to the public in the form of higher premiums paid to private medical insurance companies for medical insurance plans.

Another problem in the health care industry occurs when various medical facilities, such as doctors' offices and clinics, are not associated with various private medical insurance companies or plans. If a particular medical facility is not part of a medical insurance plan, individuals would not seek health care from these medical facilities since they would not be covered by their medical insurance plan. One reason that a medical facility would not be a participant in a certain medical insurance plan resulted from prior dealings with that medical insurance company, including an exhaustive bureaucracy structure and a large delay in being reimbursed by the medical insurance company.

The existence of the potential for medical billing fraud has been well-known for many years. Consequently, various systems and methods have been developed to endeavor to eliminate, or at least limit, the possibility of medical personnel defrauding the various medical insurance companies, as well as state and federal governments. A number of U.S. patents have issued directed to a solution for this problem.

U.S. Pat. No. 6,253,186, issued to Pendleton, Jr., describes a method and apparatus for detecting potentially fraudulent suppliers or providers of medical goods or services. A neural network is used, including software, for determining the existence of fraud after medical billing information is analyzed. A storage device includes a claims data file for storing information relating to a plurality of claims submitted for payment by a selected supplier or provider. The storage device may also include a statistics file for storing statistical information relating to a selected supplier or provider and a program for producing a statistical screening file from data contained in the neural network database and the statistics file. Although the patent to Pendleton, Jr. describes a method and apparatus for analyzing a supplier or provider to determine fraud, it does not analyze whether a particular medical provider has claimed to perform a plurality of tasks during a single time period.

U.S. Pat. No. 5,253,164, issued to Holloway et al., illustrates a system and method for detecting fraudulent medical claims via the examination of service codes. Generally, a user will enter into a computer system a description of the medical claims for which reimbursement or payment is requested, or the codes associated with such claims, or both. A history database, as well as a knowledge base interpreter, and a knowledge base are provided to determine whether fraudulent claims are being made. However, similar to the patent to Pendleton, Jr., the patent to Holloway et al. does not focus on the issue of whether a single provider is claiming to have conducted different procedures at the same time.

U.S. Pat. No. 5,933,809, issued to Hunt et al., illustrates a computer software and processing medical billing record information system consisting of hospital or individual doctor medicare billing records. The software contains at least one set of instructions for receiving, converting, sorting and storing input information from the pre-existing medical billing records into a form suitable for processing. It is noted that the patent to Hunt et al. generally is directed to a situation to identify potential medicare “72-hour billing rule” violations.

U.S. Pat. No. 5,235,702, issued to Miller, shows an automated posting of medical insurance claims system including a scanner and optical character recognition technology combined with software for verifying the medical records. Although FIG. 3 indicates in box 66 that a report is generated showing, among other things, the existence of duplicate claims, a reading of this patent would indicate that these duplicate claims are directed to one individual attempting to claim, and to be reimbursed for, receiving a treatment multiple times. This patent is not directed to a system in which one or more insurance companies, including workman's compensation, Medicare and Medicaid are asked to pay a provider for performing procedures for various patients during a single time period.

U.S. Pat. No. 4,987,538, issued to Johnson et al., details the automated processing of provider billings used for workman's compensation claims. This system includes rules provided in a computer's memory to examine specific billing documents. However, similar to the patents described hereinabove, this patent does not describe a system or method of insuring that a single provider does not bill for multiple procedure during a specified time period.

U.S. Pat. No. 5,930,759, issued to Moore et al., shows a method and system for processing health care electronic data transmissions including utilizing a network connected to a claims clearing house unit. This patent generally relates to a system or network for preparing and processing health care data transactions, such as dental or medical insurance claims and is not directed to a system similar to the system described in the present patent application.

### SUMMARY

The deficiencies of the prior art are addressed by the present invention which is directed to a system and method of endeavoring to eliminate, or at least limit, medical billing fraud due to improper or deceptive medical claims procedures being submitted to various private or public medical insurance companies for collection by various health care providers. Although the present invention was designed as a system and method for processing medical claims generated by physical therapists, it is noted that the disclosed system and method can be accommodated to include all types of medical and dental personnel including doctors, nurses, chiropractors, physical therapists, occupational therapists, dentists, dental hygienists, as well as various technicians performing a range of medical and dental procedures.

Information relating to the time a medical or similar procedure was conducted, as well as specifying the individual health care provider conducting such a procedure, would be entered in a computer system at the medical treatment facility where the health care provider provides medical treatments which would also include a diagnostic code, as well as a treatment code. This information would be transmitted to a computer system located at a clearing house, either at the time the treatment was to be performed, or at a later time, such as the end of a business day.

Both the computer system at the medical facility location, as well as the computer system located at the clearing house, would contain a software system for analyzing this data. The software system would assure that a single health care provider has appropriately billed a medical insurance company, including, but not limited to, assuring that the health care provider has not billed for multiple medical procedures at the same time.

This software system would also monitor the billing information to assure that a certain medical treatment procedure was consistent with a predetermined diagnostic code or treatment plan based upon entered procedure codes and diagnostic codes. This software system would also monitor the procedure codes to determine that two or more procedure codes for a single patient are not mutually exclusive. And, this software system will also enable the comparison of one patient record to another to determine if evidence of possible fraud may exist. If the software system determines that proper billing procedures have been followed, the health care provider would be promptly paid for his or her services.

It is therefore an object of the present invention to develop a system and method to detect medical billing fraud conditions and to prevent the payment of claims where medical billing fraud conditions have been detected.

Another object of the present invention is to assure that a particular health care provider is not billing for more than one procedure provided during a single period of time.

Yet another object of the present invention is to provide a system in which properly submitted claims are paid to a health care provider in a timely manner.

A further object of the present invention is to develop a system and method for assuring that a proper medical claim is made with regard to a particular treatment procedure associated with a predetermined diagnostic code or a predetermined treatment code.

Yet another object of the present invention is to develop a system and method for assuring that mutually exclusive medical treatment procedures are not billed for a particular patient.

A further object of the present invention is to develop a system, including a computer system located at a clearing house, wherein a plurality of health care providers and a plurality of public and private medical insurance companies, provide information to prevent the perpetuation of fraudulent or unethical medical billing practices.

And, a still further object of this invention is to enable a comparison of patient records reflecting similar medical diagnoses and similar medical procedures.

Still further advantages of the present invention will become apparent to those of ordinary skill in the art upon reading and understanding the following detailed description.

### BRIEF DESCRIPTION OF THE DRAWINGS

The system and method of the present invention will now be described with reference to the accompanying drawings, in which:

FIG. 1 is a block diagram showing the salient portions of the system of the present invention; and

FIG. 2 is a flow diagram illustrating the salient portions of the method of the present invention.

### DETAILED DESCRIPTION OF THE EMBODIMENTS

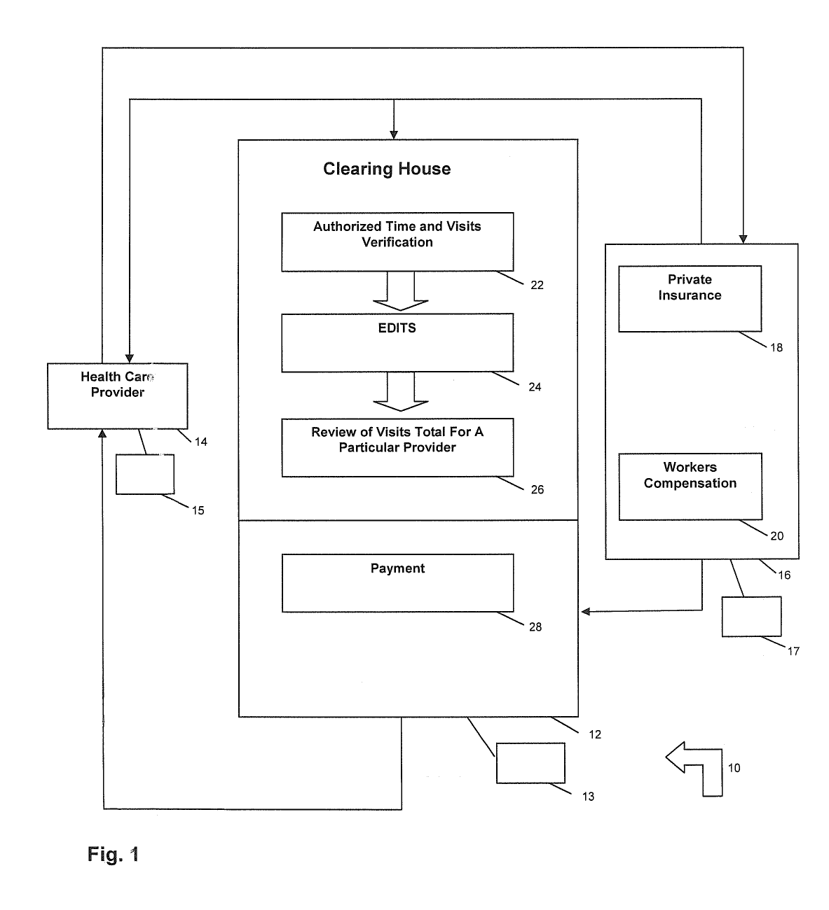

The system of the present invention 10 is illustrated in FIG. 1. A computer system 13 located at a clearing house 12 is established to process medical claims generated by a number of health care providers 14 directed to a number of private and public medical insurance companies 16. This system 10 would verify and pay the plurality of health care providers 14 for the performance of various medical or dental treatment procedures. One such health care provider is shown at 14. The purpose of the system 10 is to prevent medical billing fraud from being perpetuated on the number of medical insurance companies shown at 16. These medical insurance companies could include a number of private medical insurance companies 18, as well as public medical insurance companies, such as one overseeing the workman's compensation system as shown at 20. These public medical insurance companies could include those who administer Medicare claims, Medicaid claims, as well as other federally-sponsored or state-sponsored medical insurance programs. In addition, those who review claims and payments paid to claimants would also be able to use the present invention 10.

The computer system 13 located at the clearing house 12 includes a memory for storing a list of diagnostic codes, such as ICD8, ICD9, ICD10, as well as other listings of codes prevalent in the medical insurance industry. The memory included in the computer system 13 at the clearing house 12 would also include a listing of treatment codes, such as the AMA physicians Current Procedural Terminology (CPT) codes, as well as other types of treatment codes, such as the Relative Value Schedule (RVS) codes. These diagnostic and treatment codes would be provided in various databases included in the computer system 13 at the clearing house 12. These treatment and diagnostic codes would generally be supplied by the medical insurance industry. It is noted that the exact type of treatment and diagnostic codes are not crucial to the present invention. What is important is that these treatment and diagnostic codes would describe the type of treatments designated for particular illnesses and conditions. However, for purposes of the present invention, it will be assumed that the CPT treatment codes would be used for the particular medical treatment and that the ICD9 diagnostic codes would be used to designate the particular illness or condition. Thus, if the records of several patients included the same diagnostic and treatment codes, but the claims for reimbursement were markedly different, such difference may be indicative of possible fraud.

Prior to, during or subsequent to a patient being treated by a health care provider 14, a representative of the health care provider 14 would enter the appropriate CPT treatment codes for the medical treatment provided, as well as the ICD9 diagnostic code or codes into a computer system 15 located at the medical facility where the health care provider 14 provides medical treatment. Software included on the health care provider's computer system 15, would be responsible for transmitting the patient data and the billing data to the computer system 13 at the clearing house 12 using various standard communication links, such as, but not limited to, radio frequency communication, dedicated telephone lines or the Internet.

The software included in the health care provider's computer system 15 would additionally do a basic data check to assure that the billing and other information has been entered correctly. This information would also include information relating to the health care provider 14, such as a health care provider code and a health care provider license number. This is particularly important if a number of health care providers 14 provide medical treatment at a single medical facility.

The computer system 13 at the clearing house 12 would be provided with software having the ability to communicate with the computer system 15 at the medical facility where each of the health care providers 14 provides medical treatment, as well as the one or more computers 17 located at the various medical insurance companies 16. Similar to the communications link between the health care providers 14 and the computer system 13 at the clearing house 12, the communications link between the computer system 13 at the clearing house 12 and the one or more computer systems 17 at the medical insurance companies 16 would be by various communication means standard in the industry, such as, but not limited to, radio frequency communication, dedicated telephone lines and the Internet.

Many of the treatments practiced by each of the health care providers 14 would only be allowed if pre-approved by the various medical insurance companies 16. If this is the case, a pre-authorization or pre-treatment approval code would be transmitted from the computer systems 17 at the medical insurance companies 16 to the computer system 13 at the clearing house 12, as well as to the computer system 15 at the medical facility where the health care provider 14 provides medical treatment.

Generally, the communication link between the computer system 17 at the medical insurance companies 16, regarding this pre-authorization or pre-treatment approval, would be electronic in nature. Although communication between the computer systems 17 at the medical insurance companies 16 and the computer system 15 at the medical facility where the health care provider 14 provides medical treatment, relating to this pre-authorization or pre-treatment approval, could also be electronic, the communication might include a standard pre-authorized paper form generated by the computer system 17 at the medical insurance companies and hand delivered to the health care provider 14 by a patient. This pre-authorization or pre-treatment approval would be compared to information sent to the computer system 13 at the clearing house 12 by the computer system 15 at the medical facility where the health care provider 14 provides medical treatment. In this manner, the computer system 13 at the clearing house 12 would then verify that the treatment indicated by the health care provider 14 for a particular patient was indeed authorized at 22. The software system provided at the computer system 13 at the clearing house 12 would also allow the computer system 13 located at the clearing house 12 to determine whether the predetermined CPT treatment code was appropriate for a particular ICD9 diagnostic code, as well as determining whether a plurality of predetermined CPT treatment codes for a particular patient are mutually exclusive. This determination would be made at the EDITS section 24.

The computer system 13 at the clearing house 12 would also have the ability to determine whether a health care provider 14 was properly billing a particular medical insurance company 16 for various treatments or whether fraudulent multiple medical billing procedures were practiced at 26. Any non-adherence to the medical insurance industry's practice for one of the health care providers 14 would be transmitted to the computer system 17 at the appropriate medical insurance company 16. Obviously, if fraudulent medical billing procedures were discovered, the health care provider 14 would not be paid for these treatments. If the possibility of fraudulent medical billing procedures was discovered from a comparison of patients' records, then payment of the health care provider could be delayed until an investigation of possible billing fraud could be completed. However, if the software system in the computer system 13 at the clearing house 12 indicates that the health care provider 14 has passed the verification process, this data would also be sent to the computer system 17 at the particular medical insurance company 16 for payment. The computer system 13 at the clearing house 12 would notify the computer system 15 at the medical facility where the health care provider 14 provides medical treatment that it passed the verification process and the health care provider 14 would be timely paid within perhaps one, two or three days, as shown at 28.

The payment made by the computer system 13 at the clearing house 12 would then be reimbursed by the appropriate medical insurance company 16. Although virtually any operating program could be utilized, the present system 10 is designed to run in currently available Windows® operating systems.

The disclosed system 10 would be able to generate various types of daily, weekly and monthly reports which include a billing history and transaction codes with status, as well as the automated entry of billing information. Billing receipts would be generated in a timely manner and basic input rules would be utilized to prevent inaccurate billing before transmittal. As indicated hereinabove, various types of communication links standard in the industry would be utilized between the computer system 15 at the medical facility where the health care provider 14 provides medical treatment, the computer system 13 at the clearing house 12 and the computer systems 17 at the various medical insurance companies 16, such as the Internet or direct dial 800 numbers.

The software system utilized by the present invention could be a self-contained software program in which all billing information is keyed and transmitted. This approach would require all the interfaces for both patient and information billing information. The software system could be used in an office in which no existing software product is included and would therefore require no coordination with existing software providers.

A second approach would be designing a basic add-on software system or specification so that existing medical practice management software providers can develop the software add-on software system themselves. Since the health care providers would be in possession of some existing medical practice management software, this add-on software system might benefit from greater levels of acceptance. Additionally, the add-on software system would not require duplicate keying of data because pertinent information is exported from the medical practice management software system. Support/product responsibility is aimed at a data center only and not at health care provider offices. Office personnel would require little training because existing medical practice management software would be used.

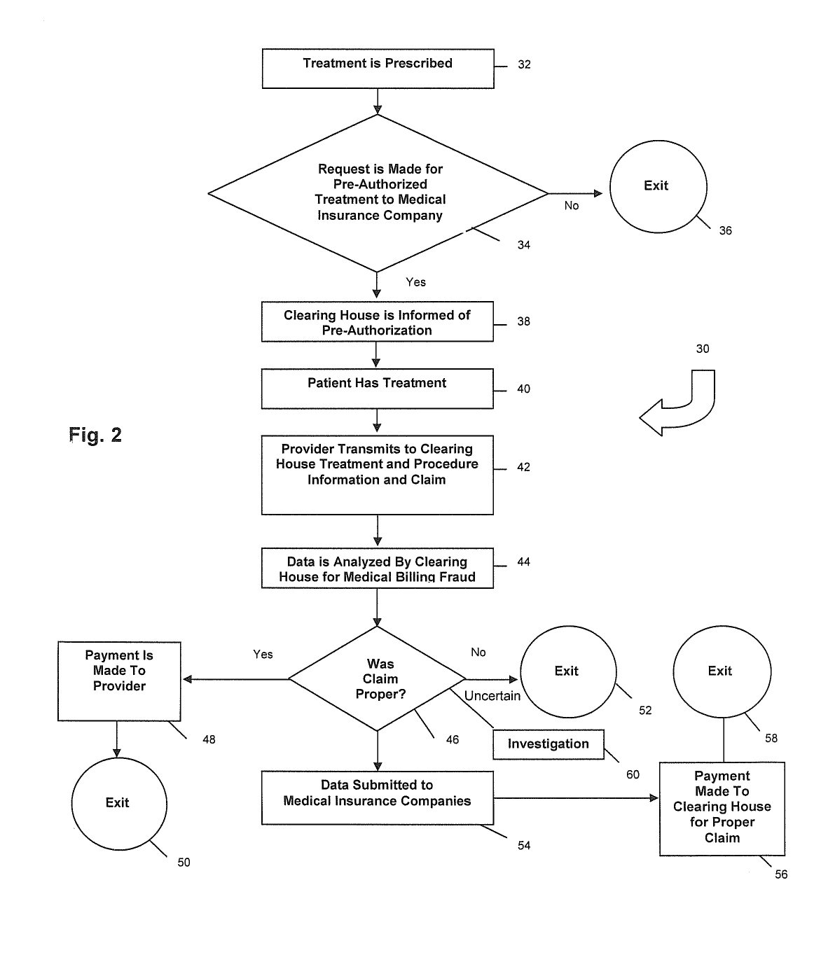

A method 30 utilizing the system shown in FIG. 1 is illustrated in FIG. 2. Initially, a particular treatment would be prescribed 32 based upon the existence of a certain condition or diagnosis by the appropriate health care provider. Since the majority of all treatments must be pre-authorized, a request for pre-authorization or pre-treatment approval is made at 34 for such a pre-authorization or pre-treatment approval from the appropriate medical insurance company 16. If this request for pre-authorization or pre-treatment approval is denied, no further action is necessary and an exit is made from the software program at 36. If the request for pre-authorization or pre-treatment approval 34 is granted, the appropriate medical insurance company 16 would inform the computer system 13 at the clearing house 12 at 38 of this pre-authorization or pre-treatment approval.

As previously discussed, the computer system 15 at the medical facility where the health care provider 14 provides medical treatment would also be informed of the pre-authorization or pre-treatment approval. Therefore, prior to, during or after the patient has received treatment at step 40, the computer system 15 at the medical facility where the health care provider 14 provides medical treatment would transmit to the computer system 13 at the clearing house 12 appropriate data relating to this treatment at step 42. This data would include a provider code, a provider license number, the proper ICD9 diagnostic code, as well as the proper pre-authorized CPT treatment code. This information would include data relating to the particular individual health care provider 14 who conducted the treatment. This data is analyzed by the computer system 13 at the clearing house 12 at step 44 to determine whether the claim for treatment was proper at step 46. If the claim for treatment was proper, payment would be made to the health care provider 14 at step 48 from the computer system 13 at the clearing house 12 and the software program would exit at step 50.

If the claim for treatment was deemed not to be proper, the software program would exit at step 52 and no payment would be made to the health care provider 14. In either instance, data would then be submitted to the computer system 17 at the proper medical insurance company 16 at step 54. If the claim for treatment was proper, payment, at step 56, would be made to the computer system 13 at the clearing house 12 and the software program would exit at step 58. Similarly, if the claim for treatment was deemed to be improper at step 46, the computer system 17 at the proper medical insurance company 16 would be informed of this situation. Presumably, the computer system 15 at the medical facility where the health care provider 14 provides medical treatment would also be informed of the non-allowance of a particular claim for treatment. If the claim for treatment is determined to be uncertain because of the possibility of being improper, payment would be withheld pending resolution of any investigation 60 relating to the potential for medical billing fraud.

The present invention envisions a system 10 in which data is entered and analyzed in various manners. In the embodiment illustrated in FIG. 1, each of the health care providers 14 would be provided with a credit-type card, including a bar code depicted thereon. The health care provider's computer system 15 would include a reader for reading this bar code. This bar code reader could take the form of a card swipe reader, a wand reader or a similar device for entering bar code information into the computer system 15 located at the medical facility where the health care provider 14 provides medical treatment. The appropriate CPT treatment code, as well as the ICD9 diagnostic codes can be entered into the computer system 15 located at the medical facility where the health care provider 14 provides medical treatment by reading the appropriate bar code from a card or similar device including all of the treatment and diagnostic codes thereon.

The health care provider 14 would also indicate the time period in which the particular treatment was administered. Alternatively, information can be keyed into the computer system 15 located at the medical facility where the health care provider 14 provides medical treatment utilizing a standard keyboard or similar device for entering the appropriate information therein. Information relating to the treatment provided and the health care provider 14 would be entered contemporaneously with the identification of the treatment being administered.

Instead of entering the information at the time the treatment was administered, the health care provider 14 may choose to enter all the information for a particular day, including the health care provider's identification number, the identification number of each of the patients, as well as the diagnostic code and treatment code associated with each of the treatments provided at the end of the day. This information could be keyed into the computer system 15 located at the medical facility where the health care provider 14 provides medical treatment utilizing either of the two entry systems described hereinabove.

After receiving the data from the computer system 15 at the medical facility where the health care provider 14 provides medical treatment, the computer system 13 at the clearing house 12 will then analyze the data to determine whether any fraudulent or inappropriate billing information was submitted. For example, the software system provided in the computer system 13 at the clearing house 12 could be used to calculate the amount of treatment time submitted by each particular health care provider/technician. If a particular health care provider/technician billed out more treatment hours than was possible, the appropriate medical insurance companies 16 would be notified. Additionally this software system 13 in the computer system at the clearing house 12 would have the ability to determine whether a particular treatment code corresponds with the associated diagnostic code or treatment request. If this occurs, the computer system 17 located at the appropriate medical insurance company 16 would be notified and payment would be denied to the health care provider 14. Furthermore, the software at the computer system 13 at the clearing house 12, according to the present invention, would be able to determine whether mutually exclusive treatment codes were submitted for the same patient. If this was the case, payment would also be denied to the health care provider 14.

Additionally, since the software system at the computer system 13 at the clearing house 12 would monitor claims made by a single health care provider 14 to a number of different medical insurance companies 16, the system and method of the present invention would be able to determine whether a single health care provider claimed treatment for more than one patient during a single time period. If this situation occurred, particularly if this information was transmitted from the health care provider 14 to the computer system 13 at the clearing house 12 during the same day, payment would be denied to the provider 14 for all claims made during a specific period of time during that day and the appropriate medical insurance companies 16 would be notified. Finally, if the health care provider 16 made a claim for a particular period of time and received payment for a treatment during that time, any subsequent claim for a treatment during that particular period of time would then be denied by the computer system 13 at the clearing house 12 and the appropriate medical insurance company 16 would then be notified.

Having described the preferred embodiments of the present invention, it is believed that other modifications, variations and changes will be suggested to those skilled in the art in view of the description set forth above. It is therefore to be understood that all such modifications, variations and changes are believed to fall within the scope of the invention as defined in the appended claims.

1. A system to prevent medical billing fraud in costs submitted to medical insurance companies for payment for treatment provided by a health care provider at a medical facility, said system comprising:
a computer located at the medical facility where treatment is provided by the health care provider;
a computer located at a clearing house;
one or more computers located at one or more medical insurance companies;
said medical facility computer being capable of receiving information including one or more of the following items:
one or more predetermined treatment codes for the treatment provided by the health care provider;
one or more diagnostic codes;
one or more health care provider codes;
one or more health care provider license numbers;
billing information including one or more of the following items:
the health care provider providing the treatment;
the time of the treatment;
the treatment provided:
said medical facility computer including software for checking if the information received has been entered correctly;
said medical facility computer further including means for communicating with said clearing house computer;
said clearing house computer being capable of communicating with said medical facility computer;
said clearing house computer being capable of communicating with said one or more medical insurance company computers;
said clearing house computer further including a data base of both diagnostic and treatment codes as well as software for determining if medical billing fraud conditions exist, such medical billing fraud conditions including one or more of the following:
a single treatment provided by multiple health care providers;
multiple similar treatments provided by one or more health care providers;
treatment provided which is inconsistent with a predetermined diagnostic code;
treatment provided which is inconsistent with one or more predetermined treatment codes;
provision of mutually exclusive treatment procedures;
multiple procedures provided by a health care provider in a single period of time;
said clearing house computer being capable of blocking payments for treatment provided by a health care provider by the insurance company when one or more of said medical billing fraud conditions is found;
said clearing house computer being capable of suspending payments if a comparison of patient records showing similar diagnostic and treatment codes, but different claims for payment, until the differences in claims are resolved;
said clearing house computer being capable of notifying said one or more medical insurance company computers that no medical billing fraud condition were found and notifying the medical facility computer that payment can be expected for treatment provided.

2. The system as defined in claim 1 wherein pre-authorization or pre-treatment codes are provided by said one or more medical insurance company computers to said clearing computer and to said medical facility computer and where payment for treatment provided by the health care provider without the receipt of a pre-authorization or pre-treatment code will be blocked by said clearing house computer.

3. The system as defined in claim 1 further including the ability to provide reports of the activities of the health care providers, the items identified by the clearing house computer containing a medical billing fraud condition, and the money paid to the health care provider for treatments provided.

4. The system as defined in claim 1 wherein a portion of the input provided to medical facility computer is provided from the office management software at the medical facility.

5. The system as defined in claim 1 wherein a portion of the input provided to the medical facility computer is provided by one of more of: a card swipe reader, a wand reader, a bar code reader, and a keyboard.

6. The system as defined in claim 1 wherein payment to the health care provider may be blocked for all treatment provided during a period of time when the medical fraud condition of multiple procedures being provided by a health care provider in a single period of time is found.

7. The system as defined in claim 1 wherein said computer located at the medical facility where treatment is provided by the health care provider also includes said software to determine if medical billing fraud conditions exist.
